(19) United States
(12) Patent Application Publication
(10) Pub. No.: US 2006/0104470 A1
(43) Pub. Date: May 18, 2006

(54) Low profile microphone

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/253,700

(22) Filed: Oct. 20, 2005

(30) Foreign Application Priority Data
Nov. 17, 2004 (JP) 2004-333186

(51) Int. Cl. H04R 11/04

(52) U.S. Cl. 381/369; 381/355

(57) ABSTRACT

A low profile microphone includes a bottom plate adapted to be placed on a flat surface, a cover having holes through which sound waves are introduced and extending over the bottom plate, a microphone unit housed in a space defined by the bottom plate and the cover, and converting sound waves arriving via the holes of the cover into electric signals, and a circuit board housed in the space defined by the bottom plate and the cover, and carrying circuit components on a surface thereof facing with the bottom plate.

### CROSS REFERENCE TO THE RELATED APPLICATIONS

This application is based upon and claims the benefit of priority from prior Japanese Patent Application No. 2004-333,186 filed on or around Nov. 17, 2004; the entire contents of which are incorporated by reference herein.

### BACKGROUND OF THE INVENTION

### Field of the Invention

This invention relates to a low profile microphone which is placed on a desk or the like, and more particularly relates to a low profile microphone which is designed to efficiently prevent generation of noises caused by outside electromagnetic waves.

A microphone which is placed on a flat surface of a desk or the like is referred to as the “low profile microphone”. The boundary microphone is designed to have a low profile so that it is less visible. FIG. 2 of the accompanying drawings exemplifies a low profile microphone of the related art. The low profile microphone mainly includes a bottom plate 1, a cover 2, a microphone unit 3, and a circuit board 4. The bottom plate 1 is a flat die-cast plate and is placed on a flat surface of a desk or the like. The cover 2 is made of a punched plate, has a numerous holes introducing sound waves, and extends over the bottom plate 1. The bottom plate 1 and the cover 2 define a space therebetween. The circuit board 4 is positioned in the space, which is divided into two parts. The microphone unit 3 is positioned in an upper part of the foregoing space near the cover 2.

The circuit board 4 has circuit components 5 mounted on its upper surface where the microphone unit 3 is present. The cover 2 is in contact with the upper surface of the bottom plate 1, and is fixedly attached to the bottom plate 1 by inserting a screw 6 into a hole on the cover 2. The screw 6 is fitted into a column of the bottom plate 1. The microphone unit 3 receives sound waves are received via a front end (a left side shown in FIG. 2) thereof, and converts them into electric signals. A cord bushing 7 is fitted into a rear end (opposite to the front end) of the bottom plate 1. A microphone cord 8 passes through the center hole of the cord bushing 7, and outputs the electric signals converted by the microphone unit 3.

The low profile microphone is generally constituted by the bottom plate 1 and the cover 2 which is made of the punched plate in order to receive sound waves. Usually, the cover 2 having a number of screws does not seem attractive, so that it is fixedly attached to the bottom plate 1 using a screw which is inserted into a hole near the center of the cover 2 and into a projection of the bottom plate 1. The cover 2 and the bottom plate 1 serve as a shield for the circuit board 4 on which the microphone unit 3, an impedance transformer, a tone controller and an output circuit are mounted.

The cover 2 is made by pressing a punched iron sheet. Mechanical and electric connections between the cover 2 and the bottom plate 1 may be unreliable. The bottom plate 1 is prepared by the galvanized die-casting process, and has a rough surface. Therefore, these two members are in point contact with each other, so that they are not electrically connected in a stable state.

Up to now, the shield structure of the related art has protected the low profile microphone against interference of electromagnetic waves when the low profile microphone is used in a broadcasting station where relatively strong VHF or UHF electromagnetic waves fly about. However, as cellular phones become popular, microphones are frequently affected by electromagnetic waves from cellular phones. Electric waves of cellular phones usually have high frequencies. If such a cellular phone is used near the microphone, the shield structure of the related art cannot keep off noises caused by electromagnetic waves from the cellular phone.

The inventor of this application has proposed a microphone structure in which an elastic sheet is inserted between a microphone support cut from a bottom plate and a microphone unit (as described in Japanese Laid-Open Utility Model Publication No. Hei 7-043,015). However, the microphone structure is intended to enable the microphone to have a low profile and to protect it against unnecessary vibrations, but not to protect it against electromagnetic waves arriving from nearby cellular phones.

Further, the inventor has proposed a structure in which an elastic member is sandwiched between a cover and a bottom plate and enables them to be in contact with each other via a plurality of points. However, even such a structure cannot reliably reduce impedance of high frequency currents. Further, referring to FIG. 2, the circuit elements 5 on the circuit board 4 are positioned near the cover 2. When a cellular phone is brought near the cover 2, a minute amount of high frequency currents get into the microphone, and is detected by the circuit elements 5. This means that noises will be generated.

Referring to FIG. 2, the low profile microphone generally includes the circuit board 4. The circuit elements 5 are mounted on one surface of the circuit board 4, the surface facing with the cover 2 and being opposite to the surface facing with the bottom plate 1. When a large component such as an electrolytic capacitor is mounted, a gap between the electrolytic capacitor and the cover 2 is approximately several millimeters wide. If a cellular phone gets near the cover 2, the electric components 5 receive electromagnetic waves from the cellular phone, which will cause noises.

### SUMMARY OF THE INVENTION

The invention has been completed in order to overcome the problems of the related art, and provides a low profile microphone which is protected against electromagnetic waves from a cellular phone and does not cause noises.

According to the invention, there is provided a low profile microphone which includes: a bottom plate adapted to be placed on a flat surface; a cover having holes through which sound waves are introduced and which extends over the bottom plate; a microphone unit housed in a space defined by the bottom plate and the cover, and converting sound waves arriving via the holes of the cover into electric signals; and a circuit board housed in the space defined by the bottom plate and the cover, and carrying circuit components on a surface thereof facing with the bottom plate.

### BRIEF DESCRIPTION OF THE DRAWINGS

FIG. 1 is a side cross-section of a low profile microphone of the invention; and

FIG. 2 is a side cross-section of a low profile microphone of the related art.

### DETAILED DESCRIPTION OF THE INVENTION

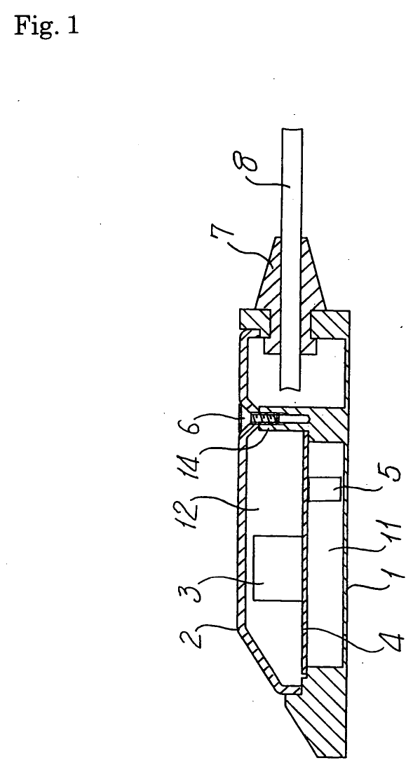

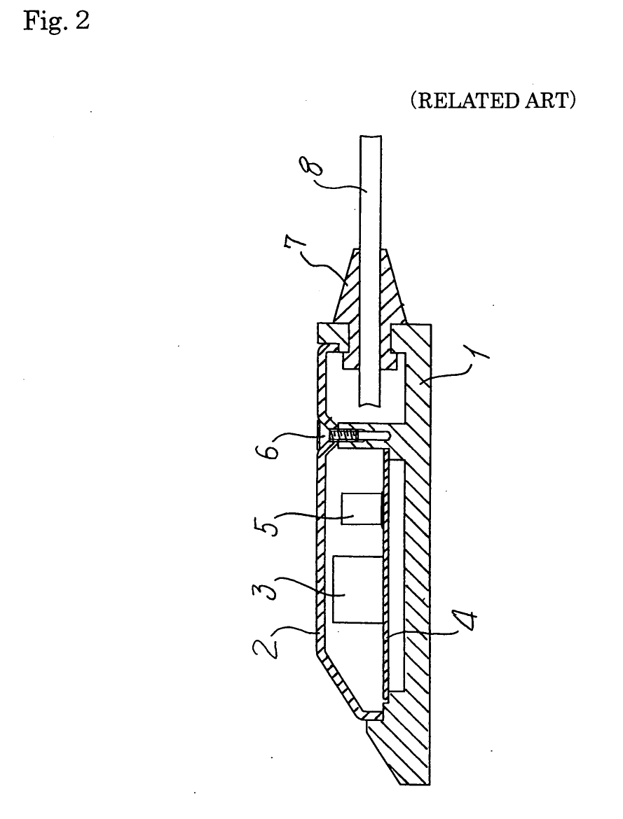

In FIG. 1, parts identical to those shown in FIG. 2 have identical reference numbers.

Referring to FIG. 1, a low profile microphone mainly includes a bottom plate 1, a cover 2, a microphone unit 3, and a circuit board 4. The bottom plate 1 is prepared by die-casting a zinc material, is flat, and can be placed on a flat surface of a desk, for example. The cover 2 is made of a punched metal sheet, receives sound waves via a number of holes thereon, and extends over the bottom plate 1. The bottom plate 1 and the cover 2 define a space, which is divided into upper and lower sections 11 and 12 by the circuit board 4. The microphone unit 3 is mounted on the upper surface of the circuit board 4 and extends in the upper section 12 of the foregoing space.

The microphone unit 3 detects sound waves arriving via the holes on the cover 2, and converts them into electric signals. The circuit board 4 has a circuit pattern and circuit components 5 on its lower surface. The circuit components 5 are positioned in the lower section 11 of the space. The cover 2 is placed on the bottom plate 1, and is coupled to the bottom plate 1 using a screw 6 which is fitted into a projection 14 of the bottom plate 1. It is assumed that sound waves are received via front end (a left end shown in FIG. 1) of the microphone. A cord bush 7 is fitted into a rear end of the bottom plate 1 (opposite to the front end). A microphone cord 8 passes through a center hole of the cord bush 7, so that electric signals are transmitted outward from the microphone unit 3.

As described so far, the circuit components 5 are positioned near the bottom plate 1, and are far from the cover 2. Even if a cellular phone or the like generating high frequency electromagnetic waves is placed near the cover 2, the circuit components 5 are not affected by high frequency electromagnetic waves, which is effective in preventing generation of noises due to high frequency electromagnetic waves from the cellular phone. The circuit board 4 includes a grounding pattern extending over a wide area thereof, and the circuit pattern which blocks electromagnetic waves from the cover 2, and efficiently prevents them from reaching the circuit components 5.

Specifically, the grounding pattern is on the upper surface of the circuit board 4 while the circuit pattern is on the lower surface of the circuit board 4, and is used to connect the circuit components 5. Further, the upper section 12 of the space is used to house the microphone unit 3 and a soldering island. The remaining part of the upper section 12 is left empty, so that the grounding pattern may be formed all over the empty area of the upper section 12. In such a case, the grounding pattern serves as a shield, which can reliably block high frequency electromagnetic waves and prevent them from reaching the circuit components 5, and generation of noises.

Alternatively, the circuit pattern may be formed on both of the upper and lower surfaces of the circuit board 4. In such a case, the circuit pattern functions as a shield, blocks outside electromagnetic waves, and prevents them reaching the circuit components 5. In any case, the circuit components 5 are on the lower surface of the circuit board 4, i.e., near the bottom plate 1.

The low profile microphone is also applicable as a sound collecting microphone in a broadcasting station or in a conference room.

What is claimed is:

1. A low profile microphone comprising:
a bottom plate adapted to be placed on a flat surface;
a cover having holes through which sound waves are introduced, the cover extending over the bottom plate;
a microphone unit housed in a space defined by the bottom plate and the cover, and converting sound waves into electric signals; and
a circuit board housed in the space defined by the bottom plate and the cover, and carrying circuit components on a surface thereof facing with the bottom plate.

2. The low profile microphone of claim 1, wherein the circuit board is provided with circuit patterns on opposite surfaces thereof.

3. The low profile microphone of claim 1, wherein the circuit board is provided with a grounding pattern on a surface thereof opposite to the surface carrying the circuit components.

4. The low profile microphone of claim 3, wherein the grounding pattern extends substantially all over the circuit board except for a soldering island, the grounding pattern being on the surface of the circuit board opposite to the surface carrying the circuit components.

5. The low profile microphone of any one of claims 1 to 4, wherein the microphone unit is positioned on the surface of the circuit board opposite to the surface where the circuit components are positioned.
